(19) United States
(12) Patent Application Publication
(10) Pub. No.: US 2024/0122248 A1
(43) Pub. Date: Apr. 18, 2024

(54) AEROSOL GENERATION DEVICE AND INFRARED HEATER

(71) Applicant: SHENZHEN FIRST UNION TECHNOLOGY CO., LTD., Shenzhen City, Guangdong Province (CN)

(72) Inventors: SHEN QI, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/555,538

(22) PCT Filed: Apr. 13, 2022
(86) PCT No.: PCT/CN2022/086649

§ 371 Date: Oct. 15, 2023

(30) Foreign Application Priority Data
Apr. 15, 2021 (CN) 202120764313.X

(51) Int. Cl. A24F 40/46; A24F 40/51

(52) U.S. Cl. CPC A24F 40/46; A24F 40/51; A24F 40/57

(57) ABSTRACT

This application provides an aerosol generation device and an infrared heater. The infrared heater includes: a base body, having a closed end and an open end, where a chamber in communication with the open end is formed therein, and the closed end is configured to be inserted into an aerosol-forming substrate received in the chamber; a carbon material containing heating body, accommodated in the chamber and extending longitudinally from a first end to a second end, where the first end is arranged close to the closed end; and a first electrode and a second electrode arranged on the carbon material containing heating body and spaced apart from each other, where both the first electrode and the second electrode are at least partially accommodated in the chamber, and the first electrode and the second electrode are configured to receive electric power.

### CROSS-REFERENCE TO RELATED APPLICATIONS

This application claims priority to Chinese Patent Application No. 202120764313.X, filed with the China National Intellectual Property Administration on Apr. 15, 2021 and entitled “AEROSOL GENERATION DEVICE AND INFRARED HEATER”, which is incorporated herein by reference in its entirety.

### TECHNICAL FIELD

This application relates to the technical field of cigarette devices, and in particular, to an aerosol generation device and an infrared heater.

### BACKGROUND

During use of smoking articles such as a cigarette or cigar, tobaccos are burnt to generate vapor. An attempt has been made to provide substitutes for these tobacco-burning articles by producing products that release compounds without burning. An example of the products is a heat-not-burn product, which releases compounds by heating tobaccos rather than burning tobaccos.

The existing aerosol generation device uses a ceramic heating body to heat a cigarette. Specifically, a heating wire is arranged in a ceramic tube. After the heating wire is energized, generated heat is conducted to the ceramic tube, and the ceramic tube further heats the cigarette. The aerosol generation device has the following problems: a poor heating effect of the ceramic heating body, insufficient release of components in the cigarette, and poor inhaling experience of users.

### SUMMARY

This application provides an aerosol generation device and an infrared heater, so as to solve the problem of a poor heating effect of a ceramic heating body in the existing aerosol generation device.

An aspect of this application provides an aerosol generation device, including a chamber, an infrared heater, and a core configured to provide electric power.

The infrared heater includes:

an elongated base body, having a closed end and an open end, where a chamber in communication with the open end is formed therein, and the closed end is configured to be inserted into an aerosol-forming substrate received in the chamber;

a carbon material containing heating body, accommodated in the chamber and extending longitudinally from a first end to a second end, where the first end is arranged close to the closed end; and

a first electrode and a second electrode arranged on the carbon material containing heating body and spaced apart from each other, where both the first electrode and the second electrode are at least partially accommodated in the chamber; and

the first electrode and the second electrode are configured to receive the electric power, so that the carbon material containing heating body generates infrared rays and heats the aerosol-forming substrate through radiation by the base body.

Another aspect of this application provides an infrared heater for an aerosol generation device, including:

an elongated base body, having a closed end and an open end, where a chamber in communication with the open end is formed therein, and

a carbon material containing heating body, accommodated in the chamber and extending longitudinally from a first end to a second end, where the first end is arranged close to the closed end; and

a first electrode and a second electrode arranged on the carbon material containing heating body and spaced apart from each other, where both the first electrode and the second electrode are at least partially accommodated in the chamber; and

the first electrode and the second electrode are configured to receive electric power, so that the carbon material containing heating body generates infrared rays and radiates the infrared rays through the base body.

Through the aerosol generation device and the infrared heater provided in this application, the carbon material containing heating body radiates infrared rays to heat the aerosol-forming substrate. Due to penetrativity of the radiated infrared rays, a cigarette can be effectively heated, so that components in the cigarette can be fully released, thereby improving inhalation experience of users.

### BRIEF DESCRIPTION OF THE DRAWINGS

One or more embodiments are exemplarily described with reference to the corresponding figures in the accompanying drawings, and the descriptions are not to be construed as a limitation on the embodiments. Elements in the accompanying drawings that have same reference numerals are represented as similar elements, and unless otherwise particularly stated, the figures in the accompanying drawings are not drawn to scale.

FIG. 1 is a schematic diagram of an aerosol generation device according to an implementation of this application;

FIG. 2 is a schematic diagram of an aerosol generation device into which a cigarette is inserted according to an implementation of this application;

FIG. 3 is a schematic diagram of an infrared heater according to an implementation of this application;

FIG. 4 is a schematic exploded view of an infrared heater according to an implementation of this application;

FIG. 5 is a schematic cross-sectional view of an infrared heater according to an implementation of this application;

FIG. 6 is a schematic diagram of a base body of an infrared heater according to an implementation of this application;

FIG. 7 is a schematic diagram of a carbon material containing heating body in an infrared heater according to an implementation of this application; and

FIG. 8 is a schematic diagram of a body of a first electrode in an infrared heater according to an implementation of this application.

### DETAILED DESCRIPTION

For ease of understanding of this application, this application is described below in more detail with reference to the accompanying drawings and specific implementations. It should be noted that, when an element is expressed as “being fixed to” another element, the element may be directly on the another element, or one or more intermediate elements may exist between the element and the another element. When one element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the art to which this application belongs. The terms used in this specification of this application are merely intended to describe objectives of the specific implementations, and are not intended to limit this application. A term “and/or” used in this specification includes any or all combinations of one or more related listed items.

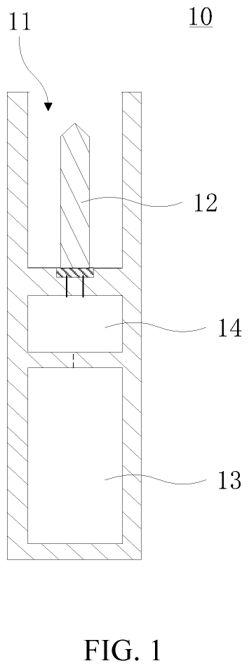

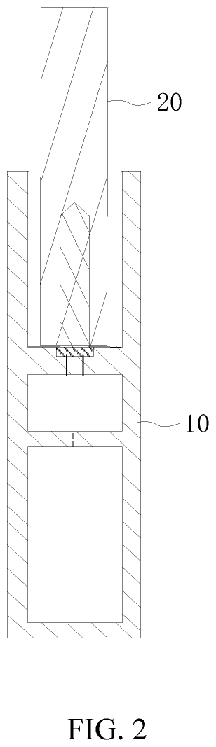

FIG. 1 to FIG. 2 show an aerosol generation device 10 according to an implementation of this application, including:

a chamber 11, configured to receive an aerosol-forming substrate, such as a cigarette 20.

The aerosol-forming substrate is a substrate that can release volatile compounds forming aerosols. The volatile compound may be released by heating the aerosol-forming substrate. The aerosol-forming substrate may be solid, liquid, or components including solid and liquid. The aerosol-forming substrate may be loaded onto a carrier or a supporting member through adsorbing, coating, impregnating, or in other manners. The aerosol-forming substrate may conveniently be a part of an aerosol generation product.

The aerosol-forming substrate may include nicotine. The aerosol-forming substrate may include tobaccos, for example, may include a tobacco-contained material including volatile tobacco-aroma compounds, and the volatile tobacco-aroma compounds are released from the aerosol-forming substrate when the aerosol-forming substrate is heated. The aerosol-forming substrate may include at least one aerosol-forming agent, and the aerosol-forming agent may be any suitable known compound or a mixture of compounds. During use, the compound or the mixture of compounds facilitates formation of a compact and stable the aerosol and is substantially resistant to thermal degradation at an operating temperature of an aerosol-forming system. Suitable aerosol-forming agents are well known in the related art and include, but are not limited to: polyol, such as triethylene glycol, 1,3-butanediol, and glycerol; polyol ester, such as glycerol acetate, glycerol diacetate, or glycerol triacetate; and fatty acid ester of monobasic carboxylic acid, dibasic carboxylic acid, or polybasic carboxylic acid, such as dimethyl dodecane dibasic ester and dimethyl tetradecane dibasic ester. Preferably, the aerosol-forming agent is polyhydric ester or a mixture thereof, such as triethylene glycol, 1,3-butanediol, or most preferably, glycerol.

An infrared heater 12 is constructed to be inserted into the aerosol-forming substrate received in the chamber 11 and heat the aerosol-forming substrate with infrared radiation.

A core 13 provides electric power for operating the aerosol generation device 10. For example, the core 13 may provide electric power to heat the infrared heater 12. In addition, the core 13 may provide the electric power required for operating other components provided in the aerosol generation device 10. The core 13 may be a rechargeable battery or a disposable battery.

A circuit 14 may control the overall operation of the aerosol generation device 10. The circuit 14 not only controls operations of the core 13 and the infrared heater 12, but also controls operations of other components in the aerosol generation device 10. For example: the circuit 14 obtains temperature information of the infrared heater 12 that is sensed by a temperature sensor, and controls, based on the information, the electric power supplied to the infrared heater 12 by the core 13.

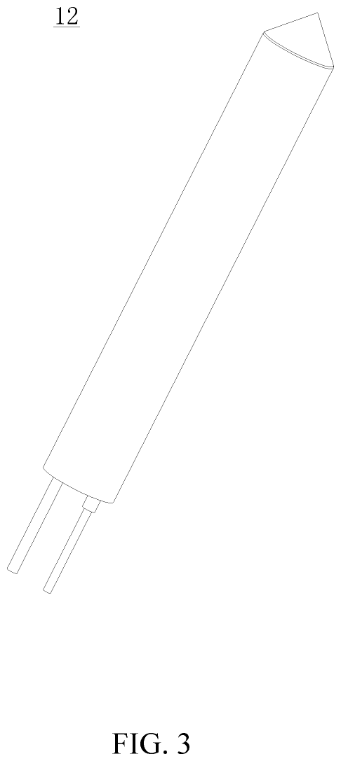

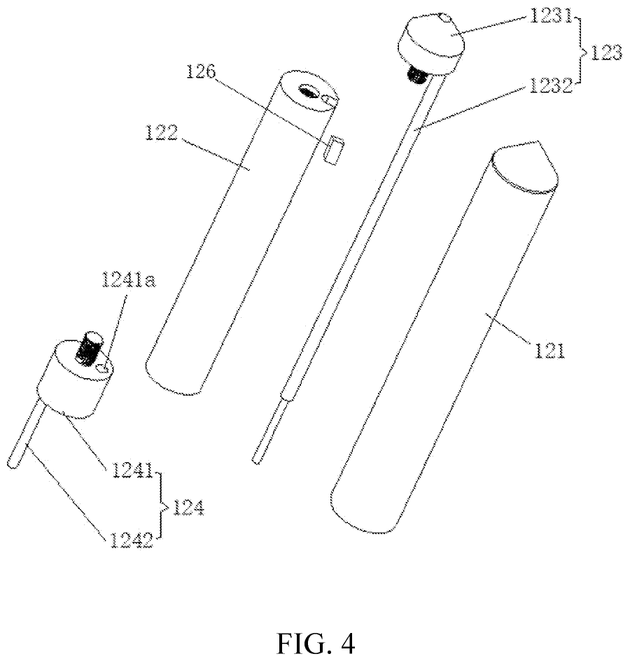

FIG. 3 to FIG. 5 show an infrared heater 12 according to an implementation of this application. The infrared heater 12 includes an elongated base body 121, a carbon material containing heating body 122, a first electrode 123, and a second electrode 124.

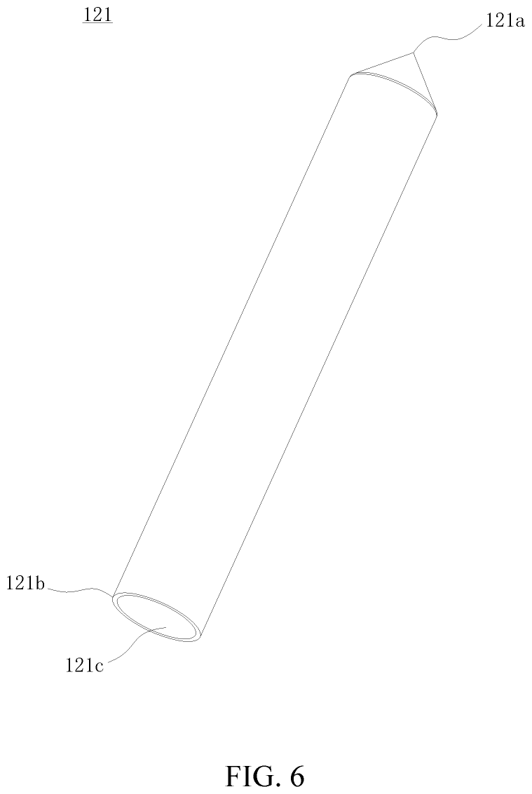

It may be understood with reference to FIG. 6 that the base body 121 has a closed end 121a and an open end 121b, and a chamber 121c in communication with the open end 121b is formed therein. The base body 121 extends longitudinally from the closed end 121a to the open end 121b, and is substantially columnar, preferably cylindrical. The closed end 121a protrudes in a conical shape, to be easily inserted into the aerosol-forming substrate.

The base body 121 may be made of a material that is high temperature-resistant and transparent, such as quartz glass, ceramic, or mica, or may be made of a material having a high infrared transmittance, for example: a high temperature-resistant material having an infrared transmittance higher than 95%, which is not specifically limited herein.

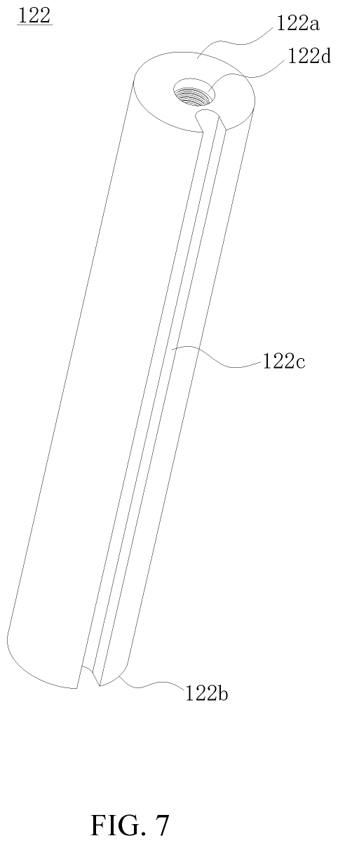

It may be understood with reference to FIG. 7 that the carbon material containing heating body 122 has a first end 122a and an opposite second end 122b. The carbon material containing heating body 122 extends longitudinally from the first end 122a to the second end 122b, and is substantially rod-shaped or columnar, preferably cylindrical. The carbon material containing heating body 122 is accommodated in the chamber 121c. Specifically, the first end 122a may be aligned with the open end 121b and inserted into the chamber 121c. In another example, the base body 121 may alternatively be blade-shaped, and the carbon material containing heating body 122 may alternatively be blade-shaped accordingly.

The carbon material containing heating body 122 is formed by pressing and high-temperature sintering of a carbon material, a bonding material, and auxiliaries. The carbon material may be selected from derivatives and compounds with carbon as part or all of the constituent elements, including but not limited to at least one of graphite, graphene, carbon fiber, carbon nanotubes, carbon black, and activated carbon. The bonding material may be selected from at least one of clay, epoxy resin, acrylic resin, or polyurethane resin. The auxiliaries may be selected from at least one of a dispersant, a defoamer, a curing agent, a thickener, and a pH regulator.

Graphite and clay materials are used as examples below to describe the implementation process of the carbon material containing heating body 122.

Step 11: Mix graphite and clay evenly according to a proportion;

step 12: press a mixture of graphite and clay in a hydraulic press mold to obtain a cylindrical pressed body; and

step 13: place cylindrical pressed body in a high-temperature furnace at 700° C. to 1000° C. for high-temperature sintering to obtain a carbon material containing heating body 122.

The obtained carbon material containing heating body 122 is electrically conductive, and can generate infrared rays and radiate to the chamber 11 through the base body 121 after conduction, thereby heating the aerosol-forming substrate received in the chamber 11.

The first electrode 123 and the second electrode 124 are configured to be coupled with the core 13 to provide the electric power of the core 13 to the carbon material containing heating body 122. The materials of the first electrode 123 and the second electrode 124 may be metals or alloys with low resistivity, such as silver, gold, palladium, platinum, copper, nickel, molybdenum, tungsten, niobium, or the above metal alloy materials.

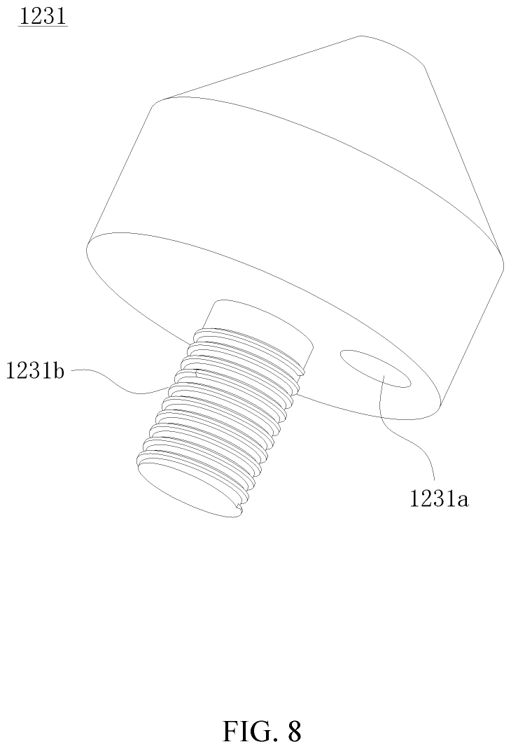

It may be understood with reference to FIG. 8 that in this example, the first electrode 123 includes a body 1231 and an electrode lead 1232. A fixing hole 1231a and a threaded post 1231b are provided on the body 1231. The second electrode 124 includes a body 1241 and an electrode lead 1242. A fixing hole, a through hole 1241a extending longitudinally, and a threaded post are provided on the body 1241.

The first end 122a of the carbon material containing heating body 122 is provided with a first electrode hole 122d, and the second end 122b of the carbon material containing heating body 122 is provided with a second electrode hole. The first electrode hole 122d and the second electrode hole are both inner threaded holes. A groove 122c is recessed in the radial direction from a part of a side surface of the carbon material containing heating body 122, and the groove 122c extends longitudinally from the first end 122a to the second end 122b.

The body 1231 is arranged at the first end 122a. Specifically, the threaded post 1231b and the first electrode hole 122d are fixed by threaded connection. The body 1241 is arranged at the second end 122b, which is fixed in a similar manner as the body 1231. One end of the electrode lead 1232 is fixed in the fixing hole 1231a, and another end extends through the groove 122c and the through hole 1241a in sequence, and then extends to outside of the base body 121 through the open end 121b. One end of the electrode lead 1242 is fixed in the fixing hole of the body 1241, and another end extends to the outside of the base body 121 through the open end 121b.

Further, an infrared heater 12 further includes an insulating member (not shown in the figure) sleeved on the periphery of the electrode lead 1232 to form insulation with the carbon material containing heating body 122 and the second electrode 124.

Further, the infrared heater 12 further includes a temperature sensor 126. The temperature sensor 126 is arranged in the gap between the groove 122c and the inner wall of the base body 121. The circuit 14 may control electric power provided by the core 13 to the infrared heater 12 based on the temperature information of the infrared heater 12 sensed by the temperature sensor 126. It can be easily imagined that a lead for the temperature sensor 126 may also pass through the groove 122c and the through hole 1241a in sequence, and then extend to the outside of the base body 121 through the open end 121b.

In this way, the carbon material containing heating body 122 generates heat and radiates infrared rays, and then heats the aerosol-forming substrate received in the chamber 11 through the base body 121.

It should be noted that, it is also feasible to form the body 1231, the electrode lead 1232, and the threaded post 1231b in one piece, or to form the body 1241, the electrode lead 1242, and the threaded post in one piece. The fixing manner of the body 1231 and the carbon material containing heating body 122 or the body 1241 and the carbon material containing heating body 122 is not limited to the threaded connection.

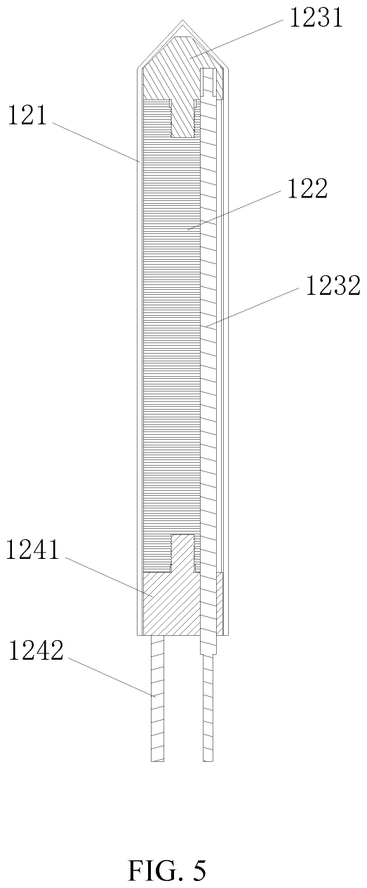

Referring to FIG. 5 for understanding, in another example, both the body 1231 and the body 1241 are arranged at the first end 122a, and the electrode lead 1232 and the electrode lead 1242 extend to the outside of the base body 121 through the open end 121b (for specific connection methods, refer to FIG. 5 and the foregoing content). In this way, after conducting electricity, the first end 122a of the carbon material containing heating body 122 first heats and radiates infrared rays, and then transfers heat from the first end 122a to the second end 122b in the longitudinal direction and radiates infrared rays. This heat transfer mode of the carbon material containing heating body 122 is close to the real tobacco combustion state, so that the components in the cigarette can be fully released, which further improves inhalation experience of users, and also improves the heating efficiency.

Further, the infrared heater 12 further includes a seal member configured to seal the open end 121b. By sealing the open end 121b, on the one hand, heat loss can be prevented, and on the other hand, oxidation of the carbon material containing heating body 122 can be prevented. The seal member may be a seal component or a seal material, for example: materials such as magnesium oxide, silicon oxide, and aluminum oxide.

Further, the infrared heater 12 further includes a base configured to hold the base body 121. It may be understood that the electrode lead 1232 and the electrode lead 1242 both extend from the base. The base may be made of a material with low thermal conductivity and high temperature resistance. For example, zirconia ceramics can withstand a temperature above 300° C. As an optional implementation, the base may be integrally formed with the base body 121. For example, the base includes a flange structure extending radially from the open end of the base body 121, and the flange structure provides mounting conditions for the infrared heater 12 to be mounted in a heating device.

It should be noted that, the specification of this application and the accompanying drawings thereof provide preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications according to the foregoing descriptions, and all the improvements and modifications shall fall within the protection scope of the appended claims of this application.

1. An aerosol generation device, comprising a chamber, an infrared heater, and a core configured to provide electric power, wherein:
the infrared heater comprises:
an elongated base body, having a closed end and an open end, wherein a chamber in communication with the open end is formed therein, and the closed end is configured to be inserted into an aerosol-forming substrate received in the chamber;
a carbon material containing heating body, accommodated in the chamber and extending longitudinally from a first end to a second end, wherein the first end is arranged close to the closed end; and
a first electrode and a second electrode arranged on the carbon material containing heating body and spaced apart from each other, wherein both the first electrode and the second electrode are at least partially accommodated in the chamber; and
the first electrode and the second electrode are configured to receive the electric power, so that the carbon material containing heating body generates infrared rays and heats the aerosol-forming substrate through radiation by the base body.

2. The aerosol generation device according to claim 1, wherein the first electrode and the second electrode each comprise a body and an electrode lead;
the body is arranged on the carbon material containing heating body and accommodated in the chamber; and
one end of the electrode lead is connected to the body, and another end extends to outside of the base body through the open end.

3. The aerosol generation device according to claim 2, wherein the body of the first electrode is arranged at the first end, and the body of the second electrode is arranged at the second end.

4. The aerosol generation device according to claim 3, wherein the carbon material containing heating body has a groove recessed in a radial direction from a part of a side surface of the carbon material containing heating body, and the groove extends longitudinally from the first end to the second end; and
the electrode lead of the first electrode is accommodated in the groove and partially extends to the outside of the base body through the open end.

5. The aerosol generation device according to claim 4, wherein the body of the second electrode has a through hole extending longitudinally, and the electrode lead of the first electrode passes through the through hole and then extends to the outside of the base body through the open end.

6. The aerosol generation device according to claim 4, wherein the infrared heater further comprises an insulating member, and the insulating member is sleeved on a periphery of the electrode lead of the first electrode.

7. The aerosol generation device according to claim 4, wherein the infrared heater further comprises a temperature sensor, and the temperature sensor is at least partially arranged in the groove.

8. The aerosol generation device according to claim 2, wherein the body of the first electrode and the body of the second electrode are both arranged at the first end, and the carbon material containing heating body is configured to transfer heat from the first end to the second end after receiving the electric power.

9. The aerosol generation device according to claim 2, wherein a first electrode hole and a second electrode hole spaced apart from each other are arranged on the carbon material containing heating body, the body of the first electrode is fixed to the first electrode hole, and the body of the second electrode is fixed to the second electrode hole.

10. The aerosol generation device according to claim 9, wherein the body of the first electrode is threadably connected to the first electrode hole, and the body of the second electrode is threadably connected to the second electrode hole.

11. The aerosol generation device according to claim 1, wherein the infrared heater further comprises a seal member configured to seal the open end.

12. The aerosol generation device according to claim 1, wherein the carbon material containing heating body is made of a carbon material, and the carbon material comprises at least one of graphite, graphene, carbon fiber, carbon nanotube, carbon black, and activated carbon.

13. An infrared heater for an aerosol generation device, comprising:
an elongated base body, having a closed end and an open end, wherein a chamber in communication with the open end is formed therein; and
a carbon material containing heating body, accommodated in the chamber and extending longitudinally from a first end to a second end, wherein the first end is arranged close to the closed end; and
a first electrode and a second electrode arranged on the carbon material containing heating body and spaced apart from each other, wherein both the first electrode and the second electrode are at least partially accommodated in the chamber; and
the first electrode and the second electrode are configured to receive electric power, so that the carbon material containing heating body generates infrared rays and radiates through the base body.

14. The aerosol generation device according to claim 5, wherein the infrared heater further comprises an insulating member, and the insulating member is sleeved on a periphery of the electrode lead of the first electrode.
